(19) United States
(12) Patent Application Publication
(10) Pub. No.: US 2023/0376688 A1
(43) Pub. Date: Nov. 23, 2023

(54) DATA GENERATION SYSTEM, DATA GENERATION METHOD, AND RECORDING MEDIUM

(71) Applicant: NEC Corporation, Tokyo (JP)

(72) Inventors: Taizo Shibuya, Tokyo (JP); Tomo Tanaka, Tokyo (JP); Kiri Inayoshi, Tokyo (JP); Kentaro Nishida, Tokyo (JP)

(73) Assignee: NEC Corporation, Tokyo (JP)

(21) Appl. No.: 18/197,333

(22) Filed: May 15, 2023

(30) Foreign Application Priority Data
May 20, 2022 (JP) 2022-082788

(51) Int. Cl. G06F 40/284; G06F 40/30

(52) U.S. Cl. CPC G06F 40/284; G06F 40/30

(57) ABSTRACT

A data generation system includes a division unit, an extraction unit, an output unit, an input unit, and a generation unit. The division unit divides each of the plurality of sentences into tokens. The extraction unit extracts a sentence including candidates for a token to be combined as a word from a plurality of sentences based on characteristics of tokens included in the plurality of sentences. The output unit outputs a sentence including the candidates for the token to be combined. The input unit receives, as an input, an instruction to combine the candidates for the token to be combined included in the sentence output by the output unit. The generation unit generates a language resource including a word obtained by combining the candidates for the token to be combined based on the input.

This application is based upon and claims the benefit of priority from Japanese Patent Application No. 2022-82788, filed on May 20, 2022, the disclosure of which is incorporated herein in its entirety by reference.

### TECHNICAL FIELD

The present disclosure relates to a data generation system and the like.

### BACKGROUND ART

A natural language processing method is widely used as a document analysis method in a document search system or the like. In a natural language processing method, a language resource is used when a document is analyzed. An example of the language resource is a dictionary. For example, when a document in a specific field is analyzed, the accuracy of analysis can be improved by using a language resource in which many words in the field to be analyzed are registered. In the case of generating a dictionary as a language resource, the dictionary is generated, for example, by extracting a word that is a candidate to be registered in the dictionary from a document, and determining whether or not to register the word in the dictionary with reference to how the word is used in the sentence. Since determination as to whether or not registration is necessary is performed for many words extracted from the document, generation of the dictionary often requires a lot of time and workload. Therefore, it is desirable to efficiently generate language resources corresponding to each field.

When extracting a compound word from text data, the device described in Patent Document 1 (Japanese Patent Application Laid-Open No. 2016-164724) extracts a compound word not registered in a constructed dictionary, and outputs the compound word together with estimated related information.

### SUMMARY

An object of the present disclosure is to provide a data generation system and the like capable of efficiently generating a language resource related to a word included in a plurality of documents.

A data generation system according to one aspect of the present disclosure comprising: at least one memory storing instructions; and at least one processor configured to access the at least one memory and execute the instructions to: divide each of a plurality of sentences into tokens; extract a sentence including candidates for a token to be combined as a word from the plurality of sentences based on characteristics of tokens included in the plurality of sentences; output a sentence including the candidates for the token to be combined; and receive, as an input, an instruction to combine the candidates for the token to be combined included in the output sentence; and generate, based on the input, a language resource including a word obtained by combining the candidates for the token to be combined.

A data generation method according to an aspect of the present disclosure comprising: dividing each of the plurality of sentences into tokens; extracting a sentence including candidates for a token to be combined as a word from the plurality of sentences based on characteristics of tokens included in the plurality of sentences; outputting a sentence including the candidates for the token to be combined; receiving, as an input, an instruction to combine the candidates for the token to be combined included in the output sentence; and generating, based on the input, a language resource including a word obtained by combining the candidates for the token to be combined.

A non-transitory recording computer-readable recording medium according to one aspect of the present disclosure records a data generation program for causing a computer to execute: a process of dividing each of the plurality of sentences into tokens; a process of extracting a sentence including candidates for a token to be combined as a word from the plurality of sentences based on characteristics of tokens included in the plurality of sentences; a process of outputting a sentence including the candidates for the token to be combined; a process of receiving, as an input, an instruction to combine the candidates for the token to be combined included in the output sentence; and a process of generating, based on the input, a language resource including a word obtained by combining the candidates for the token to be combined.

### BRIEF DESCRIPTION OF THE DRAWINGS

Exemplary features and advantages of the present disclosure will become apparent from the following detailed description when taken with the accompanying drawings in which:

FIG. 1 is a diagram illustrating an example of a configuration of a data generation system according to a first example embodiment of the present disclosure.

FIG. 2 is a diagram illustrating an example of a token in the first example embodiment of the present disclosure.

FIG. 3 is a diagram illustrating an example of a configuration of an extraction unit according to the first example embodiment of the present disclosure.

FIG. 4 is a diagram illustrating an example of a clustered sentence according to the first example embodiment of the present disclosure.

FIG. 5 is a diagram illustrating an example of a display screen according to the first example embodiment of the present disclosure.

FIG. 6 is a diagram illustrating an example of a display screen according to the first example embodiment of the present disclosure.

FIG. 7 is a diagram illustrating an example of a display screen according to the first example embodiment of the present disclosure.

FIG. 8 is a diagram illustrating an example of a display screen according to the first example embodiment of the present disclosure.

FIG. 9 is a diagram illustrating an example of a display screen according to the first example embodiment of the present disclosure.

FIG. 10 is a diagram illustrating an example of a display screen according to the first example embodiment of the present disclosure.

FIG. 11 is a diagram illustrating an example of a display screen according to the first example embodiment of the present disclosure.

FIG. 12 is a diagram illustrating an example of a display screen according to the first example embodiment of the present disclosure.

FIG. 13 is a diagram illustrating an example of a display screen according to the first example embodiment of the present disclosure.

FIG. 14 is a diagram illustrating an example of data in the first example embodiment of the present disclosure.

FIG. 15 is a diagram illustrating an example of a display screen according to the first example embodiment of the present disclosure.

FIG. 16 is a diagram illustrating an example of data in the first example embodiment of the present disclosure.

FIG. 17 is a diagram illustrating an example of an operation flow of the data generation system according to the first example embodiment of the present disclosure.

FIG. 18 is a diagram illustrating an example of a configuration of a data generation system according to a second example embodiment of the present disclosure.

FIG. 19 is a diagram illustrating an example of an operation flow of the data generation system according to the second example embodiment of the present disclosure.

FIG. 20 is a diagram illustrating an example of a hardware configuration of the data generation system according to the example embodiment of the present disclosure.

### EXAMPLE EMBODIMENT

### First Example Embodiment

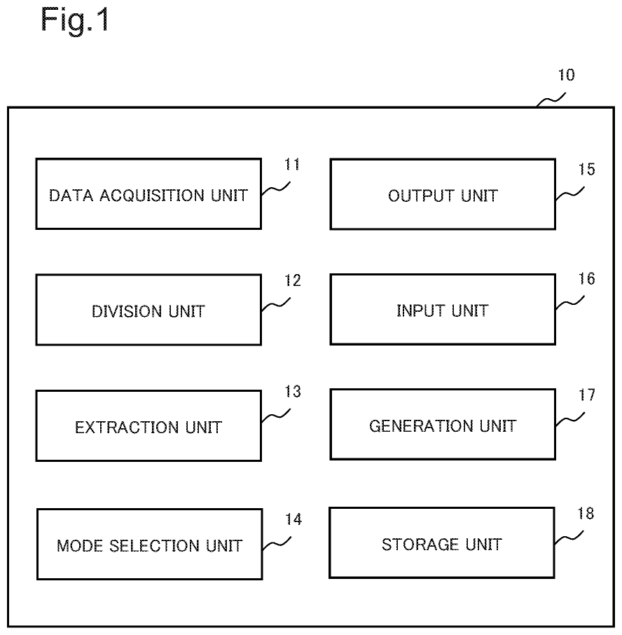

A first example embodiment of the present disclosure will be described in detail with reference to the drawings. FIG. 1 is a diagram illustrating an example of a configuration of a data generation system 10 according to the present example embodiment. The data generation system 10 of the present example embodiment includes a data acquisition unit 11, a division unit 12, an extraction unit 13, a mode selection unit 14, an output unit 15, an input unit 16, a generation unit 17, and a storage unit 18.

The data generation system 10 is a system that extracts a word included in text data and generates a language resource. The language resource is, for example, data used when a sentence is analyzed in a natural language processing method. The language resource is, for example, a dictionary used when a sentence is analyzed in a natural language processing method. The field to be analyzed refers to a field related to the text data to be analyzed. Furthermore, the language resource may be annotated text. The annotated text is, for example, data in which a tag is added to a token included in each sentence in the text. The tag includes, for example, information of a position of each token in the word and a unique expression label of the word.

The data generation system 10 is a system that generates a language resource including a word in which tokens are combined by dividing a sentence extracted from text data into tokens and combining tokens having meanings when they are combined by an operation of an operator. Having a meaning when combined means that, for example, a word generated by combining tokens is assumed to be used as a unique expression in a field to be analyzed.

The token is a word that becomes a minimum unit when a sentence is divided by, for example, morphological analysis. For example, when “kouonchoudendoutai (corresponding to the English term “high-temperature superconductor”)” is divided into tokens, the tokens are “kouon (corresponding to the English term “high temperature”)”, “chou (corresponding to the English term “super”)”, “dendou (corresponding to the English term “electrical conduction”)”, and “tai (corresponding to the English term “body”)”. The text data is also referred to as a corpus. Further, dividing the text data into words is also referred to as separating words with spaces.

A configuration of the data generation system 10 will be described with reference to FIG. 1.

The data acquisition unit 11 acquires text data used for generation of a language resource. In a case where the text data is stored in advance in the storage unit 18, the data acquisition unit 11 may not acquire the text data. The data acquisition unit 11 acquires, for example, text data input to a terminal device connected to the data generation system 10 from the terminal device by an operation of an operator. The data acquisition unit 11 may acquire text data from another server via a network. Furthermore, the text data used for generation of the language resource may be directly input to the data generation system 10. The data acquisition unit 11 stores the acquired text data in the storage unit 18.

The text data used to generate the language resource is, for example, text data of a field to be analyzed in a case where the generated language resource is used to analyze a sentence. As described above, the field to be analyzed refers to a field related to the text data to be analyzed. The field to be analyzed may include, for example, computers, applied physics, applied chemistry, architecture, economy, law, and art. The field to be analyzed may be more finely classified. For example, the field to be analyzed may be literature, movies, plays, music, and paintings in art. The field to be analyzed may be Japanese literature, Chinese literature, Russian literature, and Western literature. Furthermore, the field to be analyzed may be a newspaper, a magazine, a paper, and a title of a song. Examples of the field to be analyzed are not limited to the above.

The division unit 12 divides each of the plurality of sentences into tokens. In a case where the acquired text data is configured by a combination of a plurality of sentences, the division unit 12 divides the text data acquired by the data acquisition unit 11 into sentences. That is, in a case where the acquired text data is divided for each sentence, the division unit 12 may not divide the text data into sentences.

For example, the division unit 12 divides the text data into sentences by separating the text data with “.” and “,”. In addition, for example, in a case where text data is divided in advance like a title, the division unit 12 may not divide the text data. The division unit 12 adds an identifier for identifying a sentence as a sentence ID for each sentence. Furthermore, for example, in a case where an identifier is added to a sentence in advance, the division unit 12 may not add the identifier to the acquired sentence.

The division unit 12 divides the sentence into tokens by a natural language processing method. The division unit 12 divides the sentence into tokens by, for example, a morphological analysis method. The division unit 12 divides the sentence into tokens by MeCab, for example. The technique of dividing a sentence into tokens is not limited to the above.

The division unit 12 divides the sentence into tokens, for example, using the basic dictionary. As the basic dictionary, for example, an existing dictionary including unique expressions in the field related to the text data to be analyzed is used. For example, when the text data to be analyzed is a paper in the telecommunications field, an existing dictionary including unique expressions in the telecommunications field is used as the basic dictionary. In addition, the basic dictionary may be a dictionary for a wider field than the field to be analyzed. In addition, the basic dictionary may be a general-purpose dictionary for a wide range of fields. The basic dictionary is not limited to the above example.

The division unit 12 adds a token ID, which is an identifier for identifying a token, to the token extracted from the sentence. For example, the division unit 12 adds a token ID to the token by sequentially assigning numbers to newly extracted tokens among the tokens extracted from the sentences. The same tokens have the same token IDs. Therefore, the division unit 12 does not newly assign a token ID to the redundantly extracted token.

The division unit 12 stores the sentence and the token included in the sentence in the storage unit 18 in association with each other. For example, the division unit 12 stores a sentence, a sentence ID added to the sentence, a token included in the sentence, and a token ID added to each token in the storage unit 18 in association with each other. The division unit 12 may store the information indicating the token included in the sentence in the storage unit 18 as the information of the position of the separator in a case where the sentence is divided into tokens.

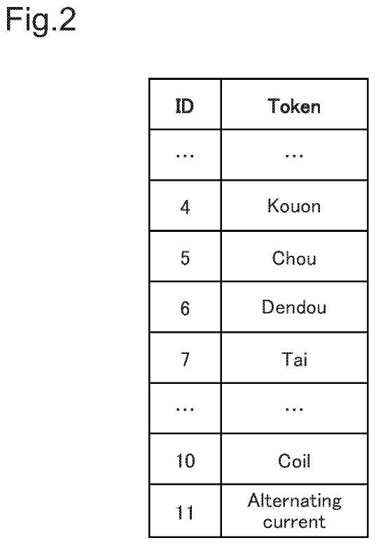

FIG. 2 is a diagram illustrating an example of a token ID added to each token. FIG. 2 illustrates an example of a token ID added to a token in a case where a sentence including “kouonchoudendoutai (corresponding to the English term “high-temperature superconductor”)” is divided into tokens. In the case of dividing a sentence including “kouonchoudendoutai (corresponding to the English term “high-temperature superconductor”)” into tokens, the division unit 12 divides “kouonchoudendoutai (corresponding to the English term “high-temperature superconductor”)” into “kouon (corresponding to the English term “high temperature”)”, “chou (corresponding to the English term “super”)”, “dendou (corresponding to the English term “electrical conduction”)”, and “tai (corresponding to the English term “body”)”, for example. When the sentence is divided into tokens, the division unit 12 sequentially adds token IDs, for example, No. 4 to “kouon (corresponding to the English term “high temperature”)”, No. 5 to “chou (corresponding to the English term “super”)”, No. 6 to “dendou (corresponding to the English term “electrical conduction”)”, and No. 7 to “tai (corresponding to the English term “body”)”. For example, the division unit 12 adds the token ID to the token related to a unique expression. That is, the division unit 12 does not add the token ID to the token commonly used in the sentence such as the particle and the auxiliary verb. In addition, the example of the token ID is not limited to the above.

The extraction unit 13 extracts a sentence including candidates for a token to be combined as a word from a plurality of sentences based on characteristics of tokens included in the plurality of sentences. The candidates for the token to be combined are, for example, a pair of tokens consecutively appearing in the sentence. For example, in a case where “Kaku (corresponding to the English term “nuclear”)” and “Yugou (corresponding to the English term “fusion”)” that are likely to be registered as the word “Kakuyugou (corresponding to the English term “nuclear fusion”)” appear consecutively in a sentence, the extraction unit 13 extracts a pair of “Kaku (corresponding to the English term “nuclear”)” and “Yugou (corresponding to the English term “fusion”)” as candidates for a token to be combined. That is, the candidates for the token to be combined are a set of tokens that can be used as a unique expression by combining them. The candidates for the token to be combined may be a set of three or more tokens that consecutively appear in the sentence.

The extraction unit 13 extracts a sentence including candidates for a token to be combined, for example, by a method of extracting a sentence including a pair of consecutive tokens in common and a method of extracting a sentence by clustering a plurality of sentences. That is, the extraction unit 13 extracts a sentence including candidates for a token to be combined by two methods of pair extraction and clustering.

The pair extraction is, for example, a method of extracting a pair of tokens that are candidates for a token to be combined from data of a sentence divided into tokens, and further extracting a sentence including the pair of tokens. In addition, clustering is a method of grouping sentences having a high possibility of including a pair of common tokens by clustering the sentences and dividing the sentences into groups for each similar sentence. Since the characteristics of the sentences are similar because they include the pair of common tokens, the sentences including the pair of common tokens are likely to be classified into the same group. The clustering technique is a technique of extracting a sentence including a pair of common tokens by using the fact that the characteristics of the tokens included in the sentence are similar. Hereinafter, a method of generating the language resource based on the candidates for the token to be combined extracted by the pair extraction is referred to as a pair mode. In addition, a method of generating a language resource based on the candidates for the token to be combined extracted by sentence clustering is referred to as a clustering mode.

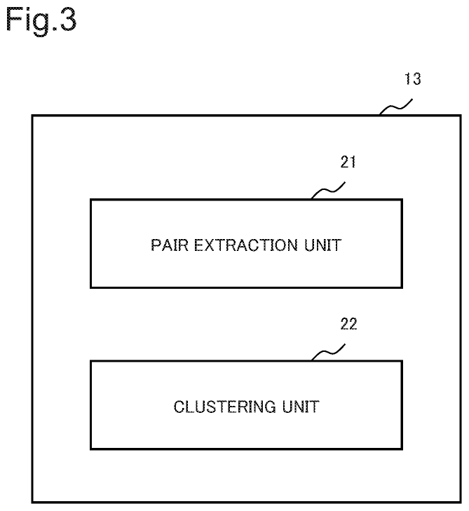

FIG. 3 is a diagram illustrating an example of a configuration of the extraction unit 13. The extraction unit 13 further includes, for example, a pair extraction unit 21 and a clustering unit 22.

The pair extraction unit 21 extracts a sentence including candidates for a token to be combined as a word from a plurality of sentences by pair extraction. The pair extraction unit 21 extracts a pair of consecutive two tokens from the sentence divided into tokens. For example, the pair extraction unit 21 counts the number of appearances of the token pair and each token included in the token pair in all the sentences included in the text data used to generate the language resource. For example, the pair extraction unit 21 stores the token ID of the token constituting the pair of tokens, the number of appearances of the pair of tokens, the number of appearances of the token, and the sentence ID of the sentence including the pair of tokens in the storage unit 18 in association with each other.

The clustering unit 22 extracts a sentence including candidates for a token to be combined as a word from a plurality of sentences by clustering the sentences. The clustering unit 22 extracts a sentence having a high possibility of including candidates for a token to be combined as a word by dividing the sentence into groups for each sentence including a common word by clustering, for example.

For example, the clustering unit 22 vectorizes sentences and clusters the sentences according to a cosine distance between vectors. The conversion of the sentence into the vector is performed by, for example, the Bag of Words method. The method of vectorization of the sentence is not limited to the above. In addition, the clustering of sentences is performed by, for example, the k-means method. The method of clustering sentences is not limited to the above.

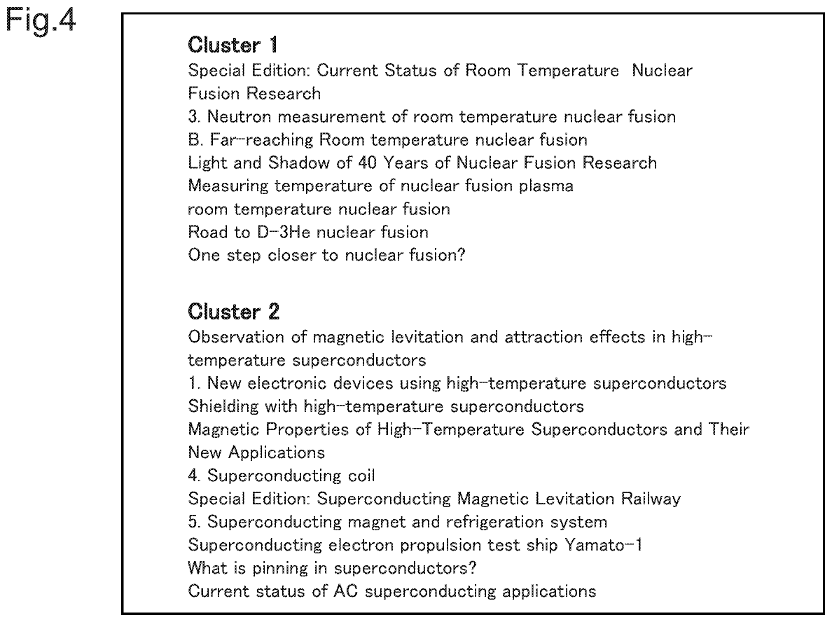

FIG. 4 illustrates an example of a result of clustering of sentences by the clustering unit 22. FIG. 4 illustrates an example of a result of clustering sentences extracted from a magazine in the field of applied physics. In the example illustrated in FIG. 4, sentences related to “Kakuyugou (corresponding to the English term “nuclear fusion”)” are classified in the group of sentences indicated as “Cluster 1”. In addition, sentences related to “Choudendou (corresponding to the English term “super conduction”)” are classified in the group of sentences indicated as “Cluster 2”. In the example illustrated as “Cluster 1” in FIG. 4, for example, a pair of tokens of “Kaku (corresponding to the English term “nuclear”)” and “Yugou (corresponding to the English term “fusion”)” is candidates for a token to be combined. Furthermore, in the example illustrated as “Cluster 2” in FIG. 4, for example, a pair of tokens of “Chou (corresponding to the English term “super”)”, “Dendou (corresponding to the English term “electrical conduction”)”, and “Tai (corresponding to the English term “body”)” is candidates for a token to be combined. The clustering unit 22 extracts a sentence including candidates for a token to be combined as a word as illustrated in FIG. 4 by clustering sentences.

The mode selection unit 14 selects one of a pair mode in which a sentence extracted as a sentence including a pair of tokens in common is used and a clustering mode in which a sentence extracted by clustering sentences is used. For example, the mode selection unit 14 receives an input as to whether to generate a language resource in a pair mode or a clustering mode, and selects a mode based on the input. The mode selection unit 14 acquires, from a terminal device, a selection result of a mode input to the terminal device by an operation of an operator, for example. The mode selection unit 14 may acquire a mode selection result directly input to the data generation system via an input device. In addition, in a case where both the pair mode and the clustering mode are performed in the order set in advance, the mode selection unit 14 may not acquire the mode selection result.

The output unit 15 outputs a sentence including the candidates for the token to be combined. For example, the output unit 15 outputs a display screen on which a sentence including the candidates for the token to be combined is displayed The output unit 15 may output a display screen according to the mode based on the selection result acquired by the mode selection unit 14. The output unit 15 outputs, for example, a sentence including candidates for a token to be combined as a display screen related to generation of a language resource. The output unit 15 outputs, for example, a display screen including a plurality of sentences including the candidates for the token to be combined, an input field of a label to be added to the word obtained by combining the tokens, and a selection field as to whether to collectively or individually perform processing of combining the tokens and adding the label. In a case where there is only one sentence including the candidates for the token to be combined, the output unit 15 may output only one sentence.

In a case where the language resource is generated in the pair mode, the output unit 15 continuously outputs, for example, sentences including the same pair of tokens. The same pair of tokens is a set of tokens that are identical in sequence with the included tokens. In a case where the language resource is generated in the pair mode, the output unit 15 outputs, for example, sentences including the candidates for the token to be combined in descending order of the appearance frequency of the pair of tokens. The output unit 15 may output a pair of tokens and an appearance frequency of each token.

In a case where the language resource is generated in the clustering mode, the output unit 15 continuously outputs, for example, sentences included in the same cluster. Furthermore, the output unit 15 sequentially outputs, for example, clusters in descending order of the number of sentences included in the same cluster.

The output unit 15 outputs all the sentences including the candidates for the token to be combined, for example, by switching the page. The page switching is performed, for example, when a page switching button set on the display screen is pressed by a mouse operation. In addition, the page switching may be performed when a preset time has elapsed since the page is switched. The page switching method is not limited to the above example. The output unit 15 may output all the sentences including the candidates for the token to be combined by scrolling the display portion of the sentence.

For example, in a case where the input unit 16 receives an input to combine tokens in a sentence, the output unit 15 sets a state indicating that the tokens in the sentence are combined on the output display screen. For example, the output unit 15 adds an underline to the combined token, thereby setting a state indicating that the tokens in the sentence are combined. The output unit 15 may display the combined token in a color different from the color of the other tokens, thereby setting a state indicating that the tokens in the sentence are combined. The output unit 15 may display the combined token in a bolder face than the other tokens, thereby setting a state indicating that the tokens in the sentence are combined. The output unit 15 may enclose the combined token in a rectangle, thereby setting a state indicating that the tokens in the sentence are combined. The output unit 15 may set the color of the background of the portion where the combined token is displayed to a color different from the color of the background of the portion where the other tokens are displayed, thereby setting a state indicating that the tokens in the sentence are combined. Furthermore, the output unit 15 may set a state indicating that the tokens in the sentence are combined by a combination of the above methods. The display method of the state indicating that the tokens in the sentence are combined is not limited to the above.

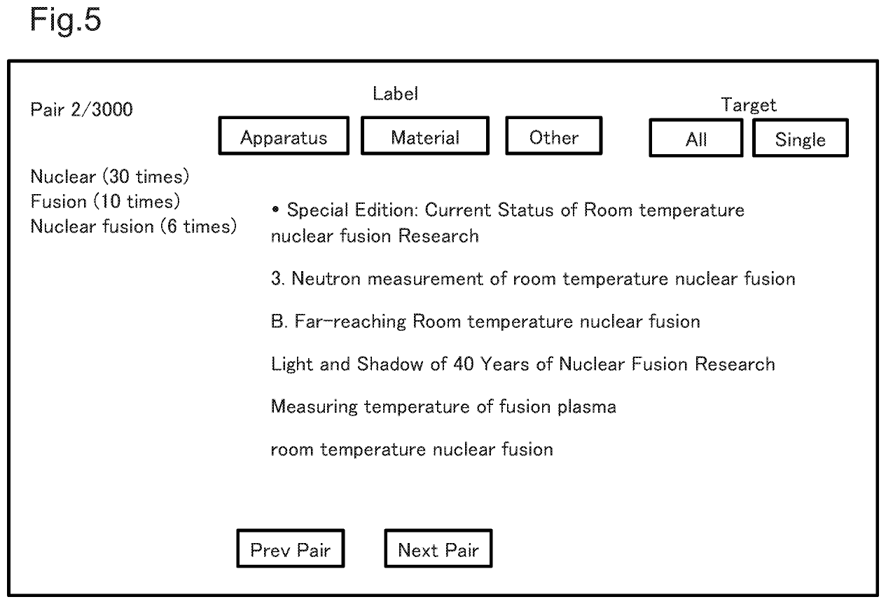

FIG. 5 is a diagram illustrating an example of a display screen of a sentence including candidates for a token to be combined in a case where the language resource is generated in the pair mode. In the example of the display screen of FIG. 5, two tokens of “Kaku (corresponding to the English term “nuclear”)” and “Yugou (corresponding to the English term “fusion”)” are extracted as a pair of candidates for the token to be combined. “Pair” in the upper left of FIG. 5 indicates that the processing is performed in the pair mode. “2/3000” indicates that the current page is the second page of the total 3000 pages. “Kaku (corresponding to the English term “nuclear”) (30 times),” “Yugou (corresponding to the English term “fusion”) (10 times),” and “Kaku yugou (corresponding to the English term “nuclear fusion”) (6 times)” indicate the number of occurrences for each token and token pair. “Label” is a button for selecting a label to be added to a word generated by combining tokens. In the example of the display screen of FIG. 5, three types of labels “Apparatus,” “Material,” and “Other” are set as “Label”. The type of label is appropriately set by an operator, for example.

“Target” in the example of the display screen of FIG. 5 is a button for selecting whether to process the same pairs of tokens collectively or individually. In the example of the display screen of FIG. 5, buttons of “All” and “Single” are set. Processing the same pairs of tokens collectively means, for example, performing, in a case where an instruction to combine any pair of tokens and a label are input, processing of setting all the pairs of tokens same as the pair of tokens instructed to be combined in a combined state and adding the same label to the pair of combined tokens. The individual processing means, for example, performing processing of combining only a pair of tokens of a sentence instructed to be combined and adding an input label.

In the example of the display screen of FIG. 5, “Prev Pair” and “Next Pair” on the lower side are buttons used when the previous page and the next page are displayed. In the example of the display screen of FIG. 5, a sentence near the center is a sentence including candidates for a token to be combined. In the example of the display screen of FIG. 5, six sentences including a pair of tokens of “Kaku (corresponding to the English term “nuclear”)” and “Yugou (corresponding to the English term “fusion”)” are displayed.

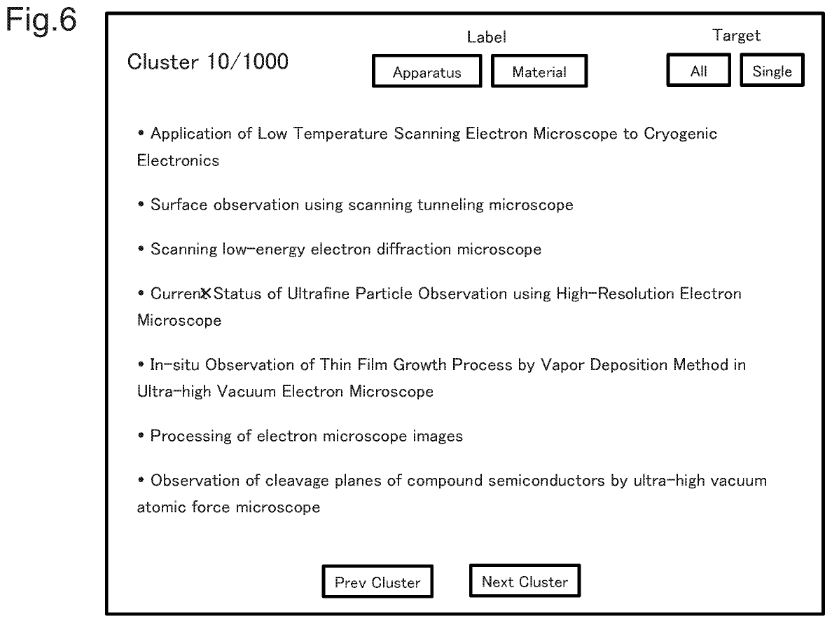

FIG. 6 is a diagram illustrating an example of a display screen of a sentence including candidates for a token to be combined in a case where the language resource is generated in the clustering mode. “Cluster” in the upper left of FIG. 6 indicates that the processing is performed in the clustering mode. “10/1000” indicates that the current page is the tenth page of the total 1000 pages. “Label” is a button for selecting a label to be added to a word generated by combining tokens. In the example of the display screen of FIG. 6, two types of labels “Apparatus” and “Material” are set as “Label”. The type of label is appropriately set by an operator, for example. “Target” is a button for selecting whether to process the same pairs of words collectively or individually. In the example of the display screen of FIG. 6, “All” and “Single” buttons are set. “Prev Cluster” and “Next Cluster” on the lower side in the example of the display screen of FIG. 6 are buttons used when the previous page and the next page are displayed. A sentence near the center in the example of the display screen of FIG. 6 is a sentence extracted by clustering. It is a sentence including candidates for a token to be combined. In the example of the display screen of FIG. 6, seven sentences are displayed.

The input unit 16 receives, as an input, an instruction to combine a token with respect to the candidates for the token to be combined. The candidates for the token to be combined are the tokens included in the plurality of sentences output by the output unit 15. When only one sentence includes the candidates for the token to be combined, the input unit 16 may receive, as an input, an instruction to combine the candidates for the token to be combined included in one sentence. For example, the input unit 16 receives, as an input, selection of candidates for a token to be combined by an operator operating the terminal device. The candidates for the token to be combined are selected, for example, by tracing the token displayed on the display screen with a cursor by mouse operation. The selection of the candidates for the token to be combined may be performed by clicking the token displayed on the display screen with a mouse operation. The method of selecting the candidates for the token to be combined is not limited to the above.

The input unit 16 may receive an input of a label to be added to a word generated by combining tokens. The input unit 16 may receive, as an input, selection of whether to collectively or individually process the candidates for the token to be combined. The input unit 16 may receive an instruction to cancel the combination of the tokens as an input. In addition, the input unit 16 may receive an instruction to change or delete the label added to the combined token as an input. For example, the input unit 16 acquires, from the terminal device, an instruction or information input by an operator operating the terminal device. The instruction or information regarding the generation of the language resource may be input via an input device connected to the data generation system 10.

Based on the input, the generation unit 17 generates, as a language resource, a dictionary in which a word obtained by combining the candidates for the token to be combined is registered. For example, the generation unit 17 adds a tag to the word in which the tokens are combined based on the instruction and the information acquired by the input unit 16, and registers the word to the dictionary including the word in which the candidates for the token are combined. When the token to be combined is selected on the display screen in the pair mode or the clustering mode, the generation unit 17 registers the word in which the tokens are combined in the dictionary. For example, the generation unit 17 registers a sentence ID including a word obtained by combining tokens and a word in the dictionary in association with each other. The generation unit 17 may register a sentence including a word obtained by combining tokens and the word in the dictionary in association with each other. The generation unit 17 may register a word and a unique expression label associated with the word in the dictionary.

The generation unit 17 generates an annotated corpus as a language resource. The annotated corpus is, for example, a tag added to each token of the tokenized text to be analyzed. For example, the generation unit 17 adds a BIO tag and a tag corresponding to a label to the word in which the tokens are combined. The BIO tag is a tag indicating the position of each token in the word in three types of B, I, and O.

B in the BIO tag means “Beginning” and indicates that it is a token at the beginning of the word. When the word obtained by combining tokens is a unique expression, the token at the beginning of the word is also referred to as a starting token of the unique expression. I in the BIO tag means “Inside” and indicates a token other than the beginning of the word. Furthermore, O in the BIO tag means “Outside,” and indicates that it is a token other than the word used as the unique expression.

For example, when a label of “Material” is added to a word, the generation unit 17 adds a tag of “B-Mat” to the token at the beginning of the word. “Mat” is a tag corresponding to the label “Material”. Furthermore, for example, when the label of “Material” is added to the word, the generation unit 17 adds a tag of “I-Mat” to the token other than the beginning of the word. The generation unit 17 may add a tag to each token included in the word by using a BIOES tag. The BIOES tag is five types of tags obtained by adding “End” and “Single” to the BIO tag. The tag added to the word by the generation unit 17 is not limited to the above. The generation unit 17 may generate a text in which the text to be analyzed is marked up with an appropriate tag as the annotated corpus.

In a case where the collective processing is selected for the combination of the tokens, the generation unit 17 combines all the candidates for the token to be combined same as the candidates for the token instructed to be combined. The generation unit 17 registers all the candidates for the token to be combined same as the candidates for the token instructed to be combined in the dictionary in association with each sentence including the candidates for the token to be combined. Then, at the time of registration in the language resource, the generation unit 17 adds the same tag to all the candidates for the token to be combined that are the same as the candidates for the token instructed to be combined.

In a case where the individual processing is selected, the generation unit 17 registers only the sentence including the candidates for the token instructed to be combined in the language resource. Then, at the time of registration to the language resource, the generation unit 17 adds a tag to the candidates for the token instructed to be combined.

In a case where the instruction to cancel the combination of the tokens is input, the generation unit 17 may delete the word for which the instruction to cancel the combination is input from the language resource. In addition, in a case where an instruction to change or delete the label added to the word is input, the generation unit 17 may change or delete the tag of the token included in the word for which the instruction to change or delete the label is input. The generation unit 17 may also perform processing of canceling the combination of the tokens and changing or deleting the label according to the selection result of collective or individual.

For example, the generation unit 17 completes the generation of the language resource when the process of combining the candidates for the token to be combined is completed for all the sentences displayed in the pair mode or the clustering mode. The generation unit 17 may complete the generation of the language resource when the process of combining the candidates for the token to be combined is completed for all the sentences displayed in both the pair mode and the clustering mode. In a case where the language resource is generated in both the pair mode and the clustering mode, the generation unit 17 may delete one of the duplicated pieces of data. The duplicated data is data registered in the language resource in both the pair mode and the clustering mode for the same candidates for the combined token included in the same sentence. In addition, the generation unit 17 completes the generation of the language resource when an instruction to complete the generation of the language resource is input by the operation of the operator.

The generation unit 17 may generate statistical data for determining the completion of generation of the language resource. For example, the generation unit 17 outputs the generated statistical data to the terminal device via the output unit 15. For example, the generation unit 17 aggregates the number of registrations of each word registered in the language resource as statistical data. The statistical data is used, for example, as data in a case where an operator who performs an operation of generating a language resource determines the appropriateness/inappropriateness of the dictionary or the annotated text generated as the language resource by looking at the registered word. For example, when receiving the instruction to complete the generation of the language resource via the input unit 16, the generation unit 17 completes the generation of the language resource. The generation unit 17 may generate statistical data for determining the completion of generation of the language resource by a word cloud method. The method for generating the statistical data for determining the completion of the generation of the language resource is not limited to the above. In addition, for example, when receiving an instruction to continue generation of the language resource via the input unit 16, the generation unit 17 may continue the processing related to generation of the language resource together with the output unit 15 and the input unit 16.

For example, the generation unit 17 stores the generated language resource in the storage unit 18. The generation unit 17 may output the generated language resource to a document analysis server connected via a network. In addition, the generation unit 17 may output the generated language resource to a language resource management server connected via a network.

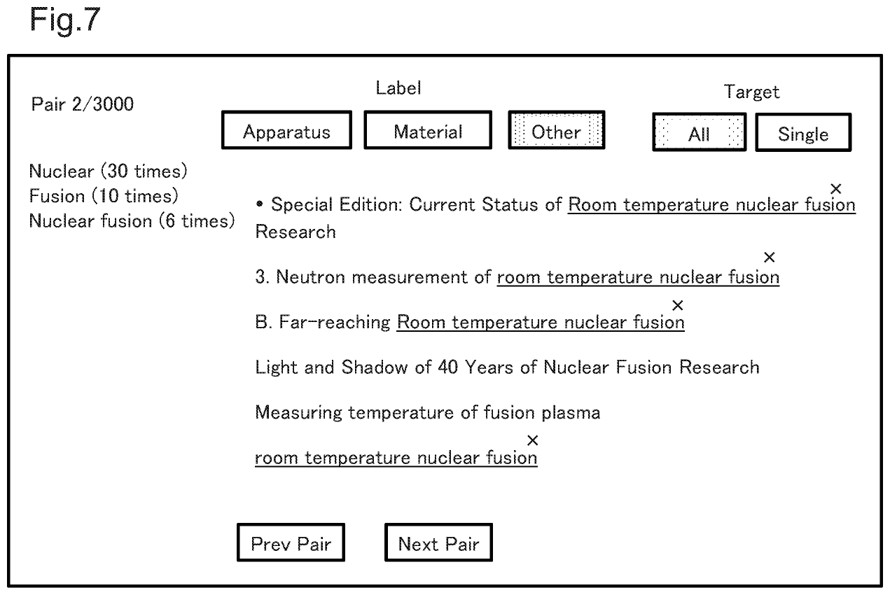

FIG. 7 is an example of a display screen in a case where the language resource is generated using the pair mode. FIG. 7 is an example of a display screen in a case where an instruction to combine three tokens of “Jouon (corresponding to the English term “room temperature”),” “Kaku (corresponding to the English term “nuclear”),” and “Yugou (corresponding to the English term “fusion”)” is input in the example of the display screen of FIG. 5. In the example of the display screen of FIG. 7, “Other” is selected as “Label.”. In the example of the display screen of FIG. 7, “All” is selected as “Target”.

For example, in the example of the display screen in FIG. 5, it is assumed that the input unit 16 receives an instruction to combine three tokens of “Jouon (corresponding to the English term “room temperature”),” “Kaku (corresponding to the English term “nuclear”),” and “Yugou (corresponding to the English term “fusion”)” in a state where “All” is selected as “Target”. In this case, the generation unit 17 brings all the sets of “Jouon (corresponding to the English term “room temperature”),” “Kaku (corresponding to the English term “nuclear”),” and “Yugou (corresponding to the English term “fusion”)” on the display screen into a combined state. Then, the generation unit 17 outputs a state in which all the sets of “Jouon (corresponding to the English term “room temperature”),” “Kaku (corresponding to the English term “nuclear”),” and “Yugou (corresponding to the English term “fusion”)” are combined via the output unit 15. In the example of the display screen of FIG. 7, an underline indicating that the tokens are combined to make “Jouonkakuyugou (corresponding to the English term “room temperature nuclear fusion”)” one word is displayed in all the sets of “Jouon (corresponding to the English term “room temperature”),” “Kaku (corresponding to the English term “nuclear”),” and “Yugou (corresponding to the English term “fusion”)”.

“×” in the example of FIG. 7 is used to cancel the combination of the tokens. For example, when any “×” is pressed while the target is in “All” state, the generation unit 17 cancels all combinations of “Jouonkakuyugou (corresponding to the English term “room temperature nuclear fusion”)” on the display screen. Then, the generation unit 17 outputs a state in which all combinations of “Jouonkakuyugou (corresponding to the English term “room temperature nuclear fusion”)” are canceled via the output unit 15. Furthermore, for example, in a case where any of “×” is pressed in a state where the target is “Single,” the generation unit 17 cancels the combination of “Jouonkakuyugou (corresponding to the English term “room temperature nuclear fusion”)” in the sentence in which “×” is pressed.

In the example of the display screen of FIG. 7, since “Other” is selected as “Label,” the generation unit 17 adds a tag corresponding to the label “Other” to “Jouonkakuyugou (corresponding to the English term “room temperature nuclear fusion”)” when combining tokens. The generation unit 17 registers the word to which the tag is added in the language resource.

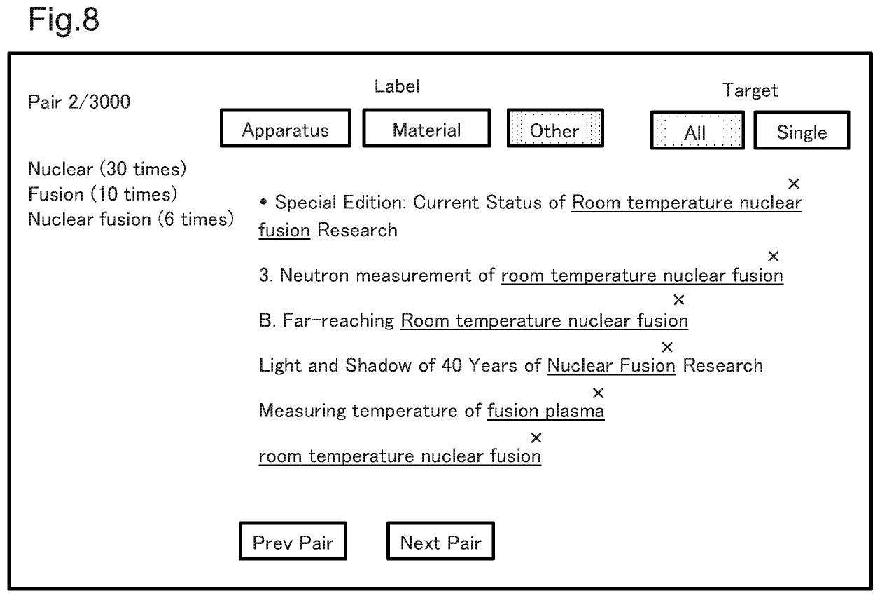

FIG. 8 is an example of the display screen of FIG. 7, and illustrates an example of the display screen in a case where an instruction to further combine “Kaku (corresponding to the English term “nuclear”)” and “Yugou (corresponding to the English term “fusion”)” is input. In the example of the display screen of FIG. 6, an underline indicating that the tokens are combined to make “Kakuyugou (corresponding to the English term “nuclear fusion”)” one word is displayed in all sets of “Kaku (corresponding to the English term “nuclear”)” and “Yugou (corresponding to the English term “fusion”)”.

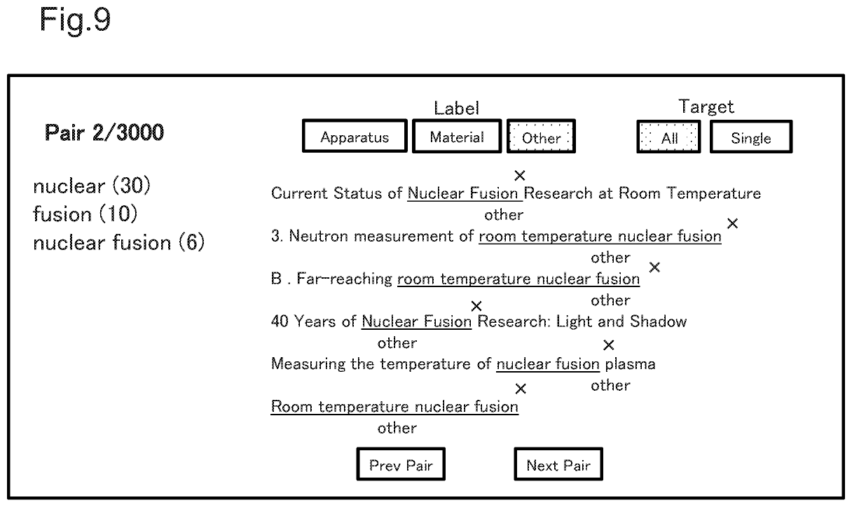

FIG. 9 is a diagram illustrating an example of a display screen when tokens obtained by dividing an English sentence are combined in the pair mode. As illustrated in FIG. 9, in the English sentence, the word in which the tokens are combined using the pair mode can be registered in the language resource in a similar manner.

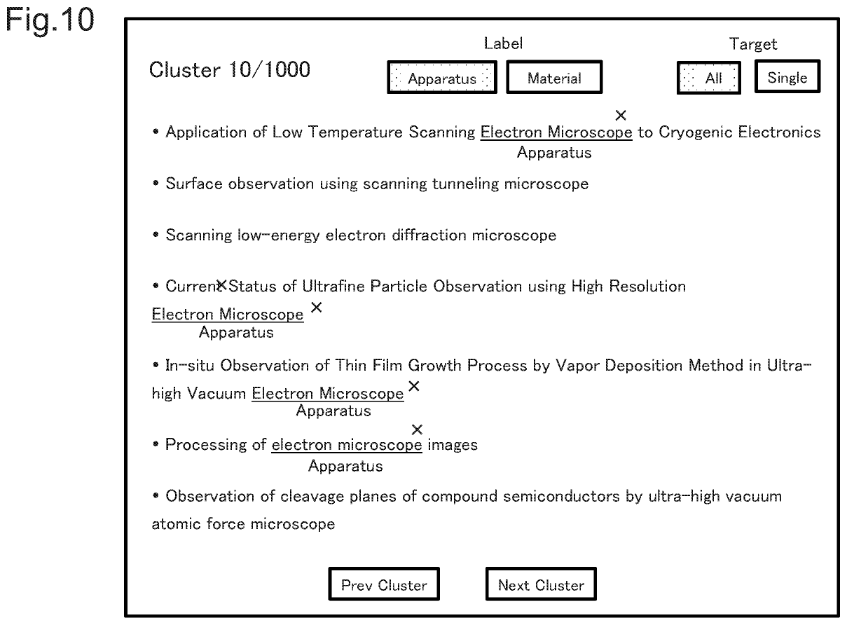

FIG. 10 is an example of a display screen in a case where the language resource is generated using the clustering mode. FIG. 10 illustrates an example of combining two tokens of “Densi (corresponding to the English term “electron”)” and “Kenbikyou (corresponding to the English term “microscope”)” in the example of the display screen of FIG. 6. In the example of the display screen in FIG. 10, “Apparatus” is selected as “Label”. In the example of the display screen in FIG. 10, “All” is selected as “Target”.

For example, in the example of the display screen of FIG. 6, it is assumed that the operator selects two tokens of “Densi (corresponding to the English term “electron”)” and “Kenbikyou (corresponding to the English term “microscope”)” in a state where “All” is selected as “Target”. In this case, the generation unit 17 brings all the sets of “Densi (corresponding to the English term “electron”)” and “Kenbikyou (corresponding to the English term “microscope”)” on the display screen into the combined state. In the example of the display screen of FIG. 10, an underline indicating that the tokens are combined to make “Densikenbikyou (corresponding to the English term “electron microscope”)” one word is displayed in all sets of “Densi (corresponding to the English term “electron”)” and “Kenbikyou (corresponding to the English term “microscope”)”.

“×” in the example of FIG. 10 is used to cancel the combination. For example, when any “×” is pressed while the target is in “All” state, the generation unit 17 cancels all combinations of “Densikenbikyou (corresponding to the English term “electron microscope”)” on the display screen. Furthermore, for example, when any of “×” is pressed in a state where the target is “Single,” the generation unit 17 cancels the combination of “Densikenbikyou (corresponding to the English term “electron microscope”)” in the sentence in which “×” is pressed.

Since “Apparatus” is selected as “Label” in the example of the display screen in FIG. 10, the generation unit 17 adds a tag corresponding to the label of “Apparatus” to “Densikenbikyou (corresponding to the English term “electron microscope”)” and registers the word in the language resource when combining the tokens.

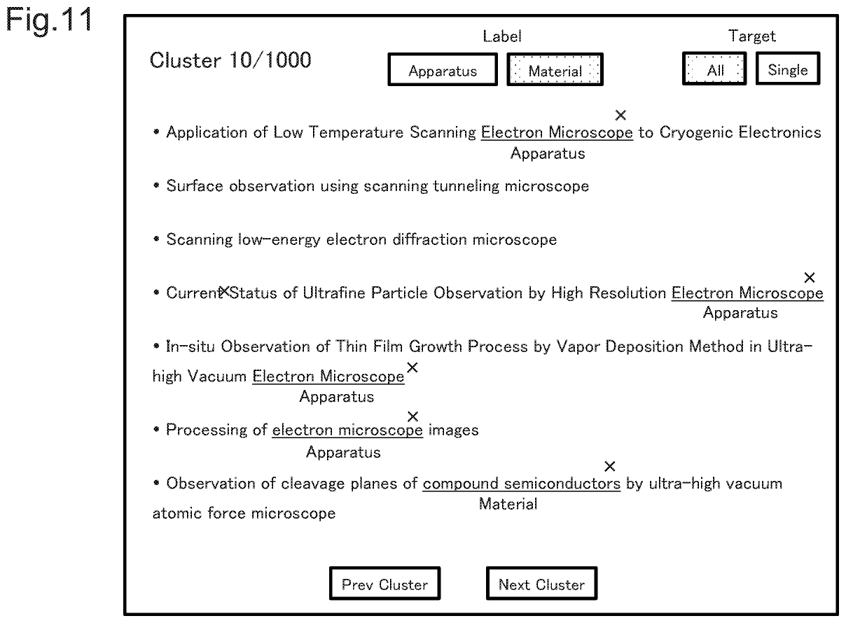

FIG. 11 illustrates an example in which “Kagou (corresponding to the English term “compound”)”, “Butsu (corresponding to the English term “object”)”, and “Handoutai (corresponding to the English term “semiconductor”)” are further selected as targets to be combined in the example of the display screen of FIG. 10. In the example of the display screen of FIG. 11, an underline indicating that the tokens are combined to make “Kagoubutsuhandoutai (corresponding to the English term “compound semiconductor”)” one word is displayed.

Furthermore, in the example of the display screen in FIG. 11, since “Material” is selected as “Label,” the generation unit 17 adds a tag corresponding to the label “Material” to “Kagoubutsuhandoutai (corresponding to the English term “compound semiconductor”)” and adds the tag to the language resource when combining the tokens.

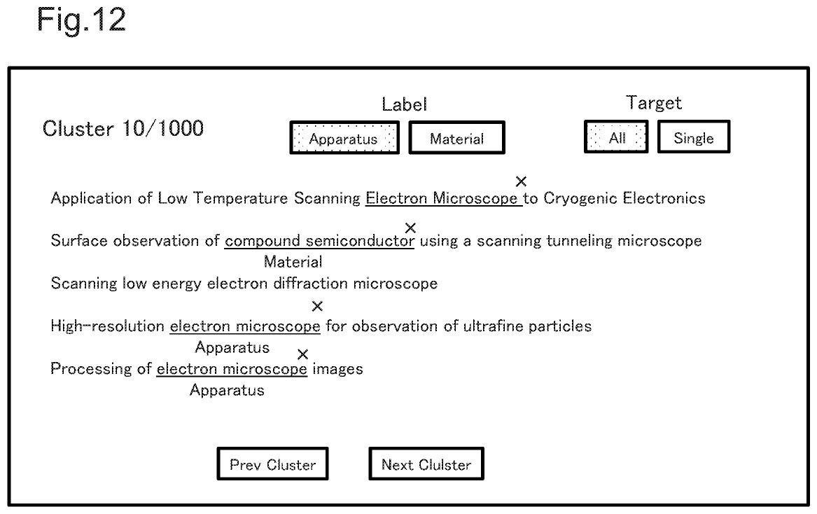

FIG. 12 is a diagram illustrating an example of a display screen when tokens obtained by dividing English sentences are combined in the clustering mode. As illustrated in FIG. 12, in the English sentence, the word in which the tokens are combined using the clustering mode can be registered in the language resource in a similar manner.

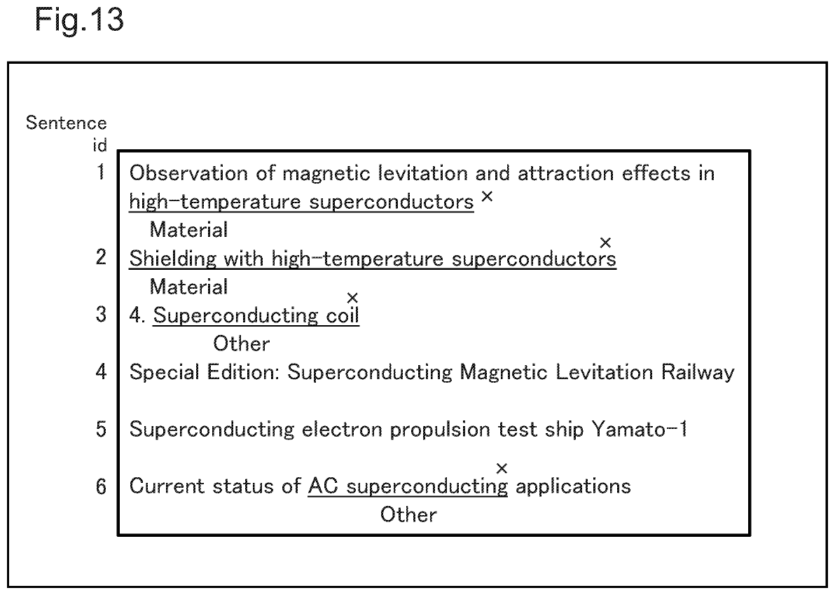

FIG. 13 is a diagram illustrating a portion that is a part of the display screen and displays a sentence including candidates for a token to be combined in an example of the display screen when the token is combined. In the example of the display screen of FIG. 13, “Material” is added as a label to “kouonchoudendoutai (corresponding to the English term “high-temperature superconductor”)”. In the example of the display screen of FIG. 13, “Other” is added as a label to “kouonchoudendoutai (corresponding to the English term “high-temperature superconductor”)”.

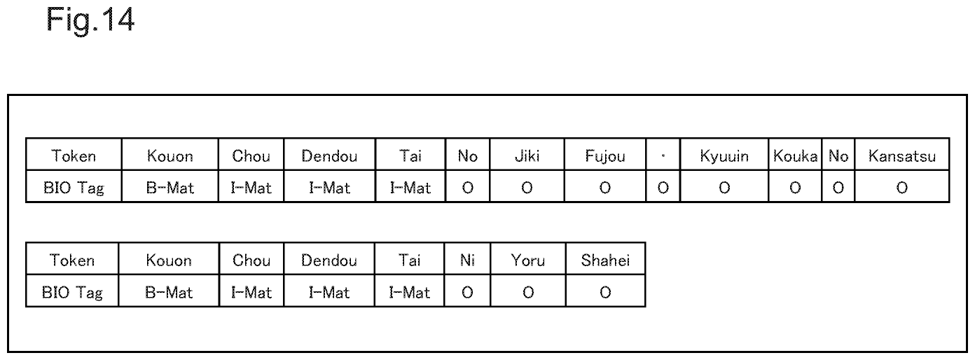

FIG. 14 is a diagram illustrating an example of language resource data to which a tag is added. In “kouonchoudendoutai (corresponding to the English term “high-temperature superconductor”)”, a tag “B” indicating that the token is the starting token of a unique expression is added to “kouon (corresponding to the English term “high temperature”)” which is the token at the beginning. In addition, a tag “I” indicating that it is a part of a unique expression is added to “Chou (corresponding to the English term “super”, “Dendou (corresponding to the English term “electrical conduction”)”, and “Tai (corresponding to the English term “body”)”. In addition, a tag “Mat” indicating “Material” is added to each token. In addition, a tag “O” indicating that the token is other than the unique expression is added to the token other than “kouonchoudendoutai (corresponding to the English term “high-temperature superconductor”)”. For example, as illustrated in FIG. 14, the generation unit 17 registers the sentence and the tag added to the token included in the sentence in the language resource in association with each other.

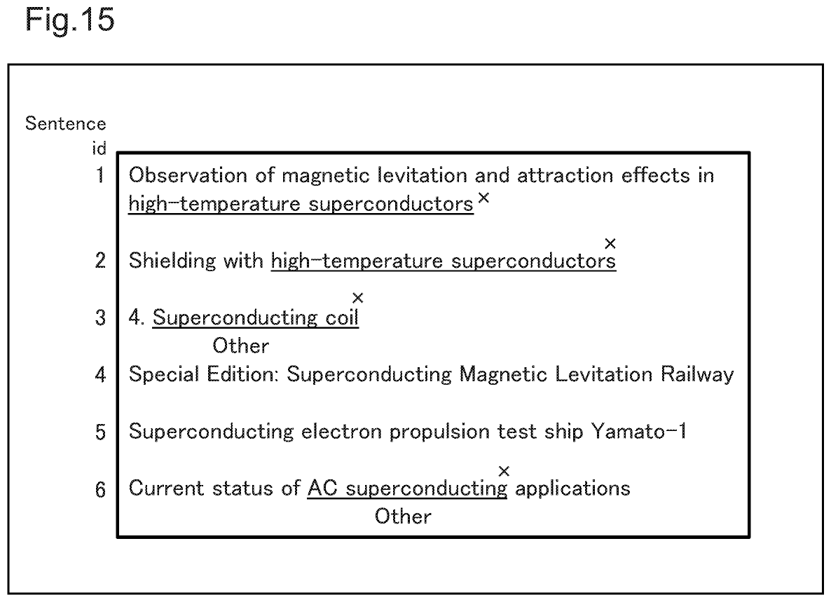

FIG. 15 is a diagram illustrating a part of a display screen in an example of the display screen when the tokens are combined. The example of FIG. 15 shows an example in which “kouonchoudendoutai (corresponding to the English term “high-temperature superconductor”)” is deleted from the example of FIG. 13.

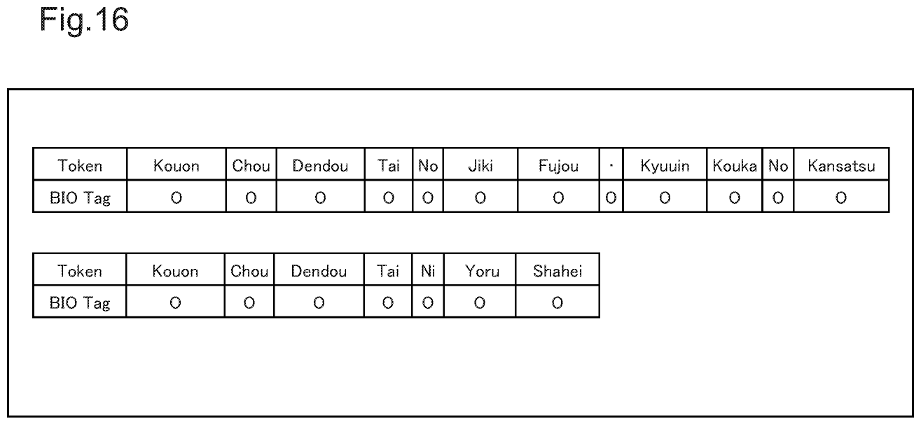

FIG. 16 is a diagram showing an example of language resource data from which “kouonchoudendoutai (corresponding to the English term “high-temperature superconductor”)” registered as a word in the example of FIG. 15 has been deleted. FIG. 16 indicates that since “kouonchoudendoutai (corresponding to the English term “high-temperature superconductor”)” has been deleted, the tag of the token constituting “kouonchoudendoutai (corresponding to the English term “high-temperature superconductor”)” has been changed to “O” indicating that it is other than the specific expression. For example, as illustrated in FIG. 16, the generation unit 17 updates the language resource by changing the tag added to the token included in the sentence.

The storage unit 18 stores each data used for generation of the language resource. The storage unit 18 stores, for example, text data acquired by the data acquisition unit 11. The storage unit 18 stores, for example, a basic dictionary. The storage unit 18 stores, for example, the sentence divided by the division unit 12 and the token. Furthermore, the storage unit 18 stores, for example, the language resource generated by the generation unit 17.

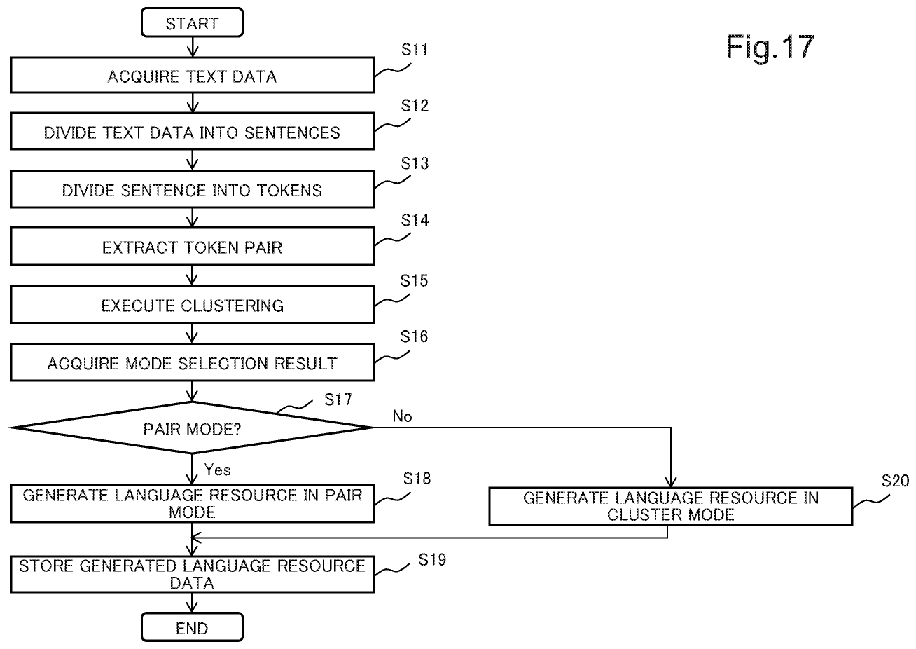

An operation of the data generation system 10 will be described. FIG. 17 is a diagram illustrating an example of an operation flow when the data generation system 10 generates a language resource.

The data acquisition unit 11 acquires text data used for generation of a language resource (step S11). When the text data used to generate the language resource is acquired, the division unit 12 divides the text data into sentences (step S12). When dividing the text data into sentences, the division unit 12 adds a sentence ID to each sentence.

When the text data is divided into sentences, the division unit 12 divides the sentences into tokens (step S13). When dividing the sentence into tokens, the division unit 12 adds the token ID to the divided token.

When the sentence is divided into tokens, the pair extraction unit 21 of the extraction unit 13 extracts a pair of tokens that are candidates for a token to be combined (step S14). When the pair of tokens is extracted, the extraction unit 13 aggregates the appearance frequency of the pair of tokens in all the sentences and the appearance frequency of the token included in the pair of tokens. The extraction unit 13 extracts a sentence including a pair of tokens, which are candidates for a token to be combined, as a sentence including candidates for a token to be combined.

Furthermore, when the sentence is divided into tokens, the clustering unit 22 of the extraction unit 13 executes clustering of sentences (step S15). The clustering unit 22 extracts a sentence from a plurality of sentences by clustering sentences. The clustering unit 22 classifies the sentences into groups for each sentence including a common word by clustering, for example. By classifying the sentences into groups for each sentence including a common word, the clustering unit 22 extracts a sentence having a high possibility of including candidates for a token to be combined. In addition, the order of the processing in step S14 and step S15 is not limited to the above. That is, the extraction unit 13 may perform the processing of step S14 after completing step S15. Furthermore, the extraction unit 13 may perform the processing of step S14 and step S15 in parallel processing.

When the sentence including the candidates for the token to be combined is extracted, the mode selection unit 14 acquires, as a mode selection result, selection as to whether to generate the language resource in the pair mode or the clustering mode (step S16).

When the mode selection result is acquired, the output unit 15 outputs a language resource generation screen corresponding to the mode selection result. In a case where the mode selection result is the pair mode (Yes in step S17), the output unit 15 outputs the language resource generation screen of the pair mode. The generation unit 17 generates the language resource in the pair mode based on the input acquired by the input unit 16 (step S18). When the processing for all the sentences including the candidates for the token to be combined is completed, the generation unit 17 stores the generated language resource data in the storage unit 18 (step S19). The generation unit 17 stores, for example, data in which a sentence and a tag added to each token included in the sentence are associated with each other in the storage unit 18 as a language resource.

In a case where the mode selection result is the clustering mode (No in step S17), the output unit 15 outputs the language resource generation screen of the clustering mode. The generation unit 17 generates the language resource in the clustering mode based on the input acquired by the input unit 16 (step S20). When the processing for all the sentences grouped by clustering is completed, the generation unit 17 stores the generated language resource data in the storage unit 18 (step S19). In addition, the generation unit 17 may generate the language resource in the mode selected in step S17 and then generate the language resource in the other mode.

The data generation system 10 according to the present example embodiment divides a sentence used for generation of a language resource into tokens, and extracts a pair of tokens that are candidates to be registered in the language resource as candidates for a token to be combined. Then, the data generation system 10 extracts a sentence including the candidates for the token to be combined. Furthermore, the data generation system 10 clusters the sentences to extract a sentence having a high possibility that the candidates for the token to be combined are commonly included. When the candidates for the token to be combined are extracted, the data generation system 10 outputs a plurality of sentences including the candidates for the token to be combined. Since the data generation system 10 outputs the plurality of sentences including the candidates for the token to be combined, the operator who generates the language resource can determine the necessity of registration of the candidates for the token to be combined as the word while comparing the plurality of sentences. As a result, by using the data generation system 10, it is possible to efficiently generate language resources related to words included in a plurality of documents. Furthermore, in a case where the data generation system 10 collectively processes the same pairs of tokens, it is possible to more efficiently generate the language resource related to the word included in the plurality of documents.

In addition, the data generation system 10 outputs the sentence extracted by two methods of a pair mode and a clustering mode when generating the language resource. Therefore, the operator who generates the language resource can perform the generation work of the language resource with reference to the two pieces of data having different tendencies. Therefore, by using the data generation system 10, it is possible to suppress overlooking or the like of the word to be registered, and to generate a more accurate dictionary.

### Second Example Embodiment

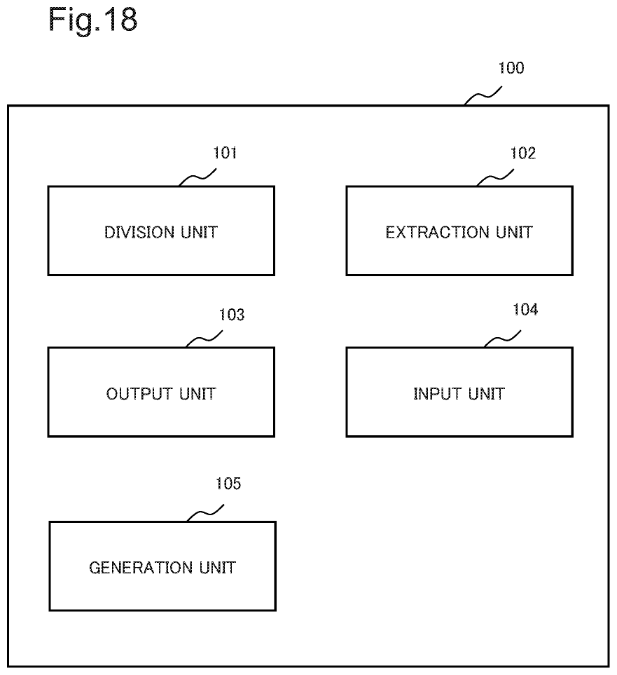

A second example embodiment of the present disclosure will be described in detail with reference to the drawings. FIG. 18 is a diagram illustrating an example of a configuration of a data generation system 100 of the present example embodiment. The data generation system 100 includes a division unit 101, an extraction unit 102, an output unit 103, an input unit 104, and a generation unit 105.

The division unit 101 divides each of a plurality of sentences into tokens. The extraction unit 102 extracts a sentence including candidates for a token to be combined as a word from a plurality of sentences based on characteristics of tokens included in the plurality of sentences. The output unit 103 outputs a sentence including the candidates for the token to be combined. The input unit 104 receives, as an input, an instruction to combine the candidates for the token to be combined included in the sentence output by the output unit 103. The generation unit 105 generates a language resource including a word obtained by combining the candidates for the token to be combined based on the input.

The division unit 12 of the first example embodiment is an example of the division unit 101. The extraction unit 13 is an example of the extraction unit 102. The output unit 15 is an example of the output unit 103. The input unit 16 is an example of the input unit 104. The generation unit 17 is an example of the generation unit 105.

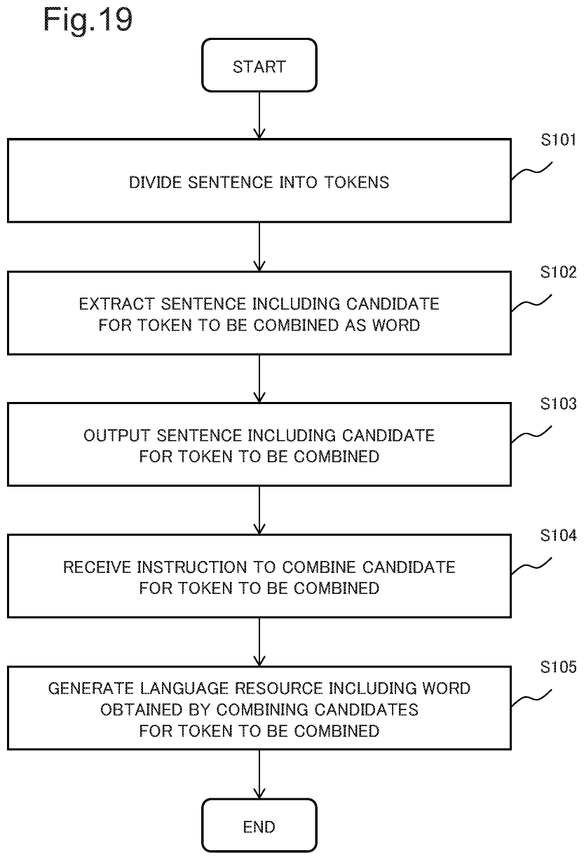

An operation of the data generation system 100 of the present example embodiment will be described. FIG. 19 is a diagram illustrating an example of an operation flow of the data generation system 100. The division unit 101 divides each of the plurality of sentences into tokens (step S101). When the sentence is divided into tokens, the extraction unit 102 extracts a sentence including candidates for a token to be combined as a word from the plurality of sentences based on the characteristics of the tokens included in the plurality of sentences (step S102). When the sentence including the candidates for the token to be combined is extracted, the output unit 103 outputs the sentence including the candidates for the token to be combined (step S103). When the sentence including the candidates for the token to be combined is output, the input unit 104 receives, as an input, an instruction to combine the candidates for the token to be combined included in the sentence output by the output unit 103 (step S104). Upon receiving an input as to whether to combine the token candidates, the generation unit 105 generates a language resource including a word obtained by combining the candidates for the token to be combined based on the input (step S105).

The data generation system 100 according to the present example embodiment outputs a plurality of sentences including the candidates for the token to be combined as words. Therefore, by using the data generation system 100, it is possible to determine the necessity of registration in the language resource with reference to how the candidates for a token to be combined as a word are used as a word in a plurality of documents. As a result, by using the data generation system 100, it is possible to efficiently generate the language resource related to the word commonly included in the plurality of documents.

In the device described in Patent Document 1, it is difficult to grasp words commonly included in a plurality of documents. Thus, there is a possibility that the amount of work for generating language resources cannot be suppressed.

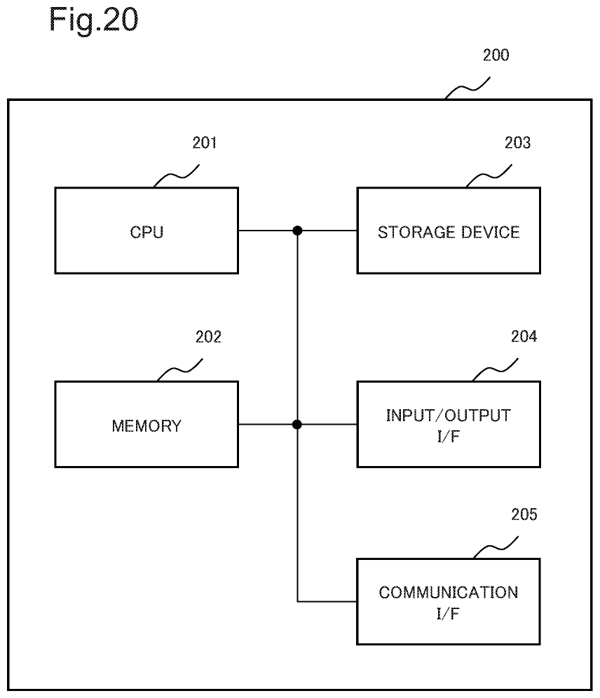

Each processing in the data generation system 10 of the first example embodiment and the data generation system 100 of the second example embodiment can be realized by executing a computer program on a computer. FIG. 20 illustrates an example of a configuration of a computer 200 that executes a computer program for performing each processing in the data generation system 10 of the first example embodiment and the data generation system 100 of the second example embodiment. The computer 200 includes a central processing unit (CPU) 201, a memory 202, a storage device 203, an input/output interface (I/F) 204, and a communication I/F 205.

The CPU 201 reads and executes a computer program for performing each processing from the storage device 203. The CPU 201 may be configured by a combination of a plurality of CPUs. The memory 202 includes a dynamic random access memory (DRAM) or the like, and temporarily stores a computer program executed by the CPU 201 and data being processed. The storage device 203 stores a computer program executed by the CPU 201. The storage device 203 includes, for example, a nonvolatile semiconductor storage device. As the storage device 203, another storage device such as a hard disk drive may be used. The input/output I/F 204 is an interface that receives an input from an operator and outputs display data and the like. The communication I/F 205 is an interface that transmits and receives data to and from another information processing apparatus.

The computer program used for executing each processing can also be stored in a non-transitory recording medium and distributed. As the recording medium, for example, a magnetic tape for data recording or a magnetic disk such as a hard disk can be used. As the recording medium, an optical disk such as a compact disc read only memory (CD-ROM) can also be used. A non-volatile semiconductor storage device may be used as a recording medium.

Some or all of the above example embodiments may be described as the following supplementary notes, but are not limited to the following.

### [Supplementary Note 1]

A data generation system comprising:
a division unit that divides each of a plurality of sentences into tokens;
an extraction unit that extracts a sentence including candidates for a token to be combined as a word from the plurality of sentences based on characteristics of tokens included in the plurality of sentences;
an output unit that outputs a sentence including the candidates for the token to be combined; and
an input unit that receives, as an input, an instruction to combine the candidates for the token to be combined included in the sentence output by the output unit; and
a generation unit that generates, based on the input, a language resource including a word obtained by combining the candidates for the token to be combined.

### [Supplementary Note 2]

The data generation system according to Supplementary Note 1, wherein
the extraction unit extracts a sentence including the candidates for the token to be combined by a pair mode of extracting a sentence including a pair of consecutive tokens in common and a clustering mode of extracting a sentence by clustering the plurality of sentences.

### [Supplementary Note 3]

The data generation system according to Supplementary Note 2, further comprising:
a mode selection unit that selects either the pair mode or the clustering mode.

### [Supplementary Note 4]

The data generation system according to Supplementary Note 3, wherein
the extraction unit counts the number of appearances in the plurality of sentences for each pair of consecutive tokens, and
the output unit outputs the number of appearances in a case where the pair mode is selected.

### [Supplementary Note 5]

The data generation system according to Supplementary Note 4, wherein
the input unit receives, as the input, a result of selecting a combination of tokens to be combined from sentences.

### [Supplementary Note 6]

The data generation system according to Supplementary Note 5, wherein
the output unit sets all sets of tokens same as a set of tokens included in the selected result in a selected state in the plurality of sentences as candidates for combination on the output display screen.

### [Supplementary Note 7]

The data generation system according to Supplementary Note 6, wherein
the input unit receives an input for canceling the selected state.

### [Supplementary Note 8]

The data generation system according to Supplementary Note 6, wherein
the generation unit generates the language resource including a word obtained by combining the combinations of the tokens in the selected state.

### [Supplementary Note 9]

The data generation system according to any one of Supplementary Notes 1 to 9, wherein
the generation unit generates the language resource by adding the same label to the same token for the tokens in the selected state.

### [Supplementary Note 10]

The data generation system according to any one of Supplementary Notes 1 to 9, wherein
the generation unit generates the language resource by associating a word obtained by combining the candidates for the token to be combined with a sentence including the candidates for the token to be combined.

### [Supplementary Note 11]

A data generation method, comprising:
dividing each of the plurality of sentences into tokens;
extracting a sentence including candidates for a token to be combined as a word from the plurality of sentences based on characteristics of tokens included in the plurality of sentences;
outputting a sentence including the candidates for the token to be combined;
receiving, as an input, an instruction to combine the candidates for the token to be combined included in the output sentence; and
generating, based on the input, a language resource including a word obtained by combining the candidates for the token to be combined.

### [Supplementary Note 12]

A non-transitory computer-readable recording medium recording a data generation program for causing a computer to execute:
a process of dividing each of the plurality of sentences into tokens;
a process of extracting a sentence including candidates for a token to be combined as a word from the plurality of sentences based on characteristics of tokens included in the plurality of sentences;
a process of outputting a sentence including the candidates for the token to be combined;
a process of receiving, as an input, an instruction to combine the candidates for the token to be combined included in the output sentence; and
a process of generating, based on the input, a language resource including a word obtained by combining the candidates for the token to be combined.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

1. A data generation system comprising:
at least one memory storing instructions; and
at least one processor configured to access the at least one memory and execute the instructions to:
divide each of a plurality of sentences into tokens;
extract a sentence including candidates for a token to be combined as a word from the plurality of sentences based on characteristics of tokens included in the plurality of sentences;
output a sentence including the candidates for the token to be combined; and
receive, as an input, an instruction to combine the candidates for the token to be combined included in the output sentence; and
generate, based on the input, a language resource including a word obtained by combining the candidates for the token to be combined.

2. The data generation system according to claim 1, wherein
the at least one processor is further configured to execute the instructions to:
extract a sentence including the candidates for the token to be combined by a pair mode of extracting a sentence including a pair of consecutive tokens in common and a clustering mode of extracting a sentence by clustering the plurality of sentences.

3. The data generation system according to claim 2, wherein
the at least one processor is further configured to execute the instructions to:
select either the pair mode or the clustering mode.

4. The data generation system according to claim 3, wherein
the at least one processor is further configured to execute the instructions to:
count the number of appearances in the plurality of sentences for each pair of consecutive tokens; and
output the number of appearances in a case where the pair mode is selected.

5. The data generation system according to claim 4, wherein
the at least one processor is further configured to execute the instructions to:
receive, as the input, a result of selecting a combination of tokens to be combined from sentences.

6. The data generation system according to claim 5, wherein
the at least one processor is further configured to execute the instructions to:
set all sets of tokens same as a set of tokens included in the selected result in a selected state in the plurality of sentences as candidates for combination on the output display screen.

7. The data generation system according to claim 6, wherein
the at least one processor is further configured to execute the instructions to:
receive an input for canceling the selected state.

8. The data generation system according to claim 6, wherein
the at least one processor is further configured to execute the instructions to:
generate the language resource including a word obtained by combining the combinations of the tokens in the selected state.

9. The data generation system according to claim 1, wherein
the at least one processor is further configured to execute the instructions to:
generate the language resource by adding the same label to the same token for the tokens in the selected state.

10. The data generation system according to claim 1, wherein
the at least one processor is further configured to execute the instructions to:
generate the language resource by associating a word obtained by combining the candidates for the token to be combined with a sentence including the candidates for the token to be combined.

11. A data generation method, comprising:
dividing each of the plurality of sentences into tokens;
extracting a sentence including candidates for a token to be combined as a word from the plurality of sentences based on characteristics of tokens included in the plurality of sentences;
outputting a sentence including the candidates for the token to be combined;
receiving, as an input, an instruction to combine the candidates for the token to be combined included in the output sentence; and
generating, based on the input, a language resource including a word obtained by combining the candidates for the token to be combined.

12. A non-transitory computer-readable recording medium recording a data generation program for causing a computer to execute:
a process of dividing each of the plurality of sentences into tokens;
a process of extracting a sentence including candidates for a token to be combined as a word from the plurality of sentences based on characteristics of tokens included in the plurality of sentences;
a process of outputting a sentence including the candidates for the token to be combined;
a process of receiving, as an input, an instruction to combine the candidates for the token to be combined included in the output sentence; and
a process of generating, based on the input, a language resource including a word obtained by combining the candidates for the token to be combined.
